(19) United States
(12) Patent Application Publication
(10) Pub. No.: US 2007/0175251 A1
(43) Pub. Date: Aug. 2, 2007

(54) Methods and systems for supporting and securing a wheel hub

(76) Inventor: Arthur Sherman, Jacksonville, FL (US)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/341,871

(22) Filed: Jan. 30, 2006

(51) Int. Cl. B60R 25/00

(52) U.S. Cl. 70/226

(57) ABSTRACT

Methods and systems for supporting and securing a wheel hub include a base and a support member. The support member includes a wheel hub cut-out configured to receive a portion of a wheel hub therethrough. The support member also includes a plurality of lug bolt cut-outs radially spaced around the circular wheel-hub cut-out. The lug bolt cut-outs are configured to receive lug bolts associated with the wheel hub. The wheel hub support system is optionally used in conjunction with a locking mechanism to secure the wheel hub support system to a wheel hub, and/or to secure the wheel hub support system to a stationary device. A locking device can include, for example, a locking lug nut. An optional lock protection mechanism protects the locking mechanism from physical force. An optional second support member assists in preventing the first support member from bending or collapsing under the weight of a supported vehicle.

### BACKGROUND OF THE INVENTION

1. Field of the Invention

The present invention relates generally to wheel hub support systems and, more particularly, securable wheel hub support systems.

2. Background Art

Wheeled vehicles, such as automobiles, trailers, and wheeled construction equipment (e.g., cement mixers, welding equipment, and tar trailers), are often the subjects of theft. A variety of conventional anti-theft systems are available. For example, conventional anti-theft systems for trailers include hitch locks. Hitch locks can, however, be broken with a blow from a solid object, such as a hammer. What are needed, therefore, are improved anti-theft systems for wheeled vehicles.

For a variety of reasons, there are times when it is desired to remove a wheel from a wheeled vehicle. For example, during long term storage of a wheeled vehicle, it is desired to take the weight off the tires to avoid flat spots. What are also needed, therefore, are systems for supporting wheeled vehicles when a wheel is removed.

### BRIEF SUMMARY OF THE INVENTION

The following summary of the invention provides an understanding of at least some aspects of the invention. The summary is not an extensive overview of the invention. It is not intended to identify key or critical elements of the invention nor is it intended to delineate the scope of the invention. Its sole purpose is to present some concepts of the invention in a simplified form as a prelude to the more detailed description that is presented later.

Methods and systems for supporting and securing a wheel hub include a base and a support member. The support member includes a wheel hub cut-out configured to receive a portion of a wheel hub therethrough. The support member also includes a plurality of lug bolt cut-outs radially spaced around the circular wheel-hub cut-out. The lug bolt cut-outs are configured to receive lug bolts associated with the wheel hub.

The wheel hub support system is optionally used in conjunction with a locking mechanism to secure the wheel hub support system to a wheel hub, and/or to secure the wheel hub support system to a stationary device. A locking device can include, for example, a locking lug nut.

An optional lock protection mechanism protects the locking mechanism from physical force.

An optional second support member assists in preventing the first support member from bending or collapsing under the weight of a supported vehicle.

Further embodiments, features, and advantages of the present inventions, as well as the structure and operation of the various embodiments of the present invention, are described in detail below with reference to the accompanying drawings. These aspects are indicative of but a few of the various ways in which the principles of the invention may be employed, and the present invention is intended to include all such aspects and their equivalents. Further features and advantages will be apparent to a person skilled in the art based on the description set forth herein and/or may be learned by practice of the invention.

It is to be understood that both the foregoing summary and the following detailed description are exemplary and explanatory and are intended to provide further explanation of embodiments of the invention as claimed.

### BRIEF DESCRIPTION OF THE FIGURES

The accompanying drawings, which are incorporated herein and form part of the specification, illustrate the present invention and, together with the description, further serve to explain the principles of the invention and to enable a person skilled in the pertinent art to make and use the invention. In the drawings, like reference numbers indicate identical or functionally similar elements. Additionally, the leftmost digit(s) of a reference number identifies the drawing in which the reference number first appears.

FIG. 1 is a front plan view of an exemplary wheel hub support system, including a base and a support member.

FIG. 2 is a look-down cross-sectional view of the wheel hub support system.

FIG. 3 is a side view of the wheel hub support system.

FIG. 4 is a perspective view of the wheel hub support system, further including an example lock protection mechanism.

FIG. 5 is a perspective view of a vehicle supported on one side by the wheel hub support system.

FIG. 6 is a perspective view of a vehicle having multiple wheels on a side, with one wheel replaced by a securable wheel hub support system.

### DETAILED DESCRIPTION OF THE INVENTION

Table of Contents

I. Introduction

II. Wheel Hub Support System

III. Locking Mechanism

IV. Lock Protection Mechanism

V. Conclusion

### I. INTRODUCTION

Methods and systems for supporting and securing a wheeled vehicle will be described more fully hereinafter with reference to the accompanying drawings, in which embodiments of the invention are illustrated. The invention may, however, be embodied in many different forms and should not be construed as limited to the example embodiments set forth herein. Rather, these embodiments are provided so that this disclosure will be thorough and complete, and will fully convey the invention to those skilled in the art.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Wheel Hub Support System

A wheel hub support system, with an optional accompanying lock, is used to support a vehicle when a tire is removed, and optionally, to secure the vehicle from unauthorized use and theft. For example, and without limitation, a wheel hub support system can be used to support and secure motorized vehicles, such as automobiles and trucks, and non-motorized vehicles such as trailers and construction equipment mounted on wheels (e.g., transportable cement mixers, welding equipment, and tar heaters).

When using a wheel hub support system to secure a vehicle, a single wheel hub support system, with accompanying lock, can be utilized. Alternatively, multiple wheel hub support systems, with accompanying locks, can be utilized on a vehicle.

A wheel hub support system, with or without an accompanying lock, can be used to support a vehicle over an extended time, so as to relieve tires from sitting stationary under load. In such a situation, the tires are removed from a vehicle and replaced with wheel hub support systems.

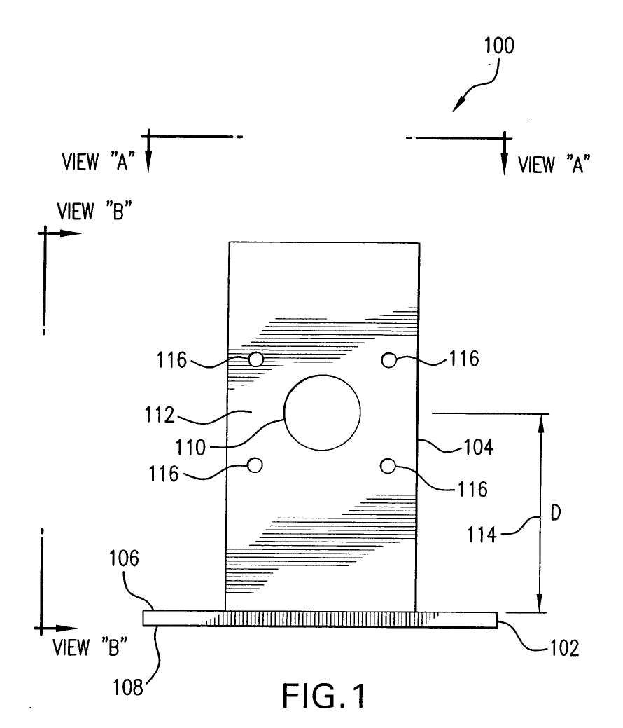

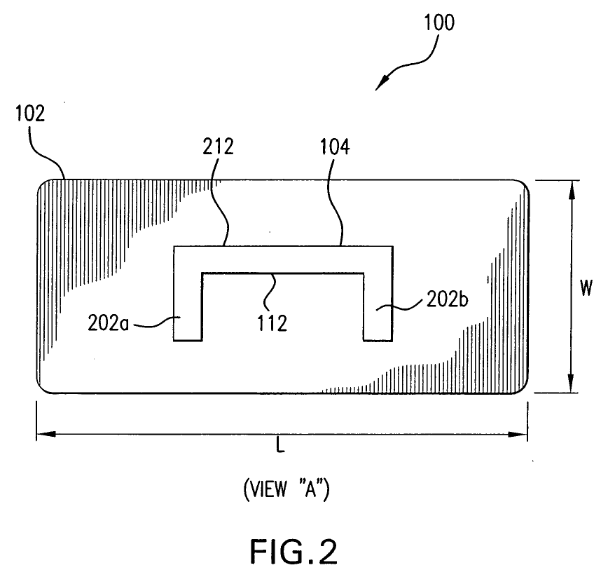

FIG. 1 is a front plan view of an exemplary wheel hub support system 100, including a base 102 and a support member 104.

In the example of FIG. 1, the base member 102 has substantially horizontal upper and lower surfaces 106 and 108, respectively. The base member 102 is made of a substantially rigid, durable material, such as metal (e.g., steel and/or aluminum), or composite materials.

The support member 104 extends upwardly from the upper surface of the base 102. The support member 104 is made of a substantially rigid, durable material, such as metal (e.g., steel and/or aluminum), or composite materials.

It should be noted that spatial references, such as “horizontal” or “upwardly extending” are only intended to describe an exemplary wheel hub support system when disposed for normal use. Such references are not limiting of the structure of the system.

The support member 104 includes a wheel hub cut-out 110 extending between a first surface 112 and second surface 212 (FIG. 2), of the support member 104. The wheel hub cut-out 110 is configured to receive a portion of a wheel hub therethrough. The center of the wheel hub cut-out 110 is positioned a distance 114 from the base so as to support a wheel hub above ground level. Generally, the distance 114 is approximately equal to the normal distance from the ground to the center point of the wheel hub when a wheel and tire are present. However, the distance 114 can be greater or less than the normal distance.

The support member 104 further includes a plurality of lug bolt cut-outs 116, radially spaced around the circular wheel-hub cut-out. The lug bolt cut-outs 116 are configured to receive lug bolts associated with the wheel hub. The number of, and the positioning of the lug bolt cut-outs 116 are selected according to a wheel hub design. For example, and without limitation, conventional wheel hubs are available in 4, 5, 6, and 8 lug bolt embodiments. The diameter and positioning of the lug bolts are typically manufacturer dependent. The diameter and positioning of the lug bolts, for various manufacturers, are publicly available.

The support member 104 is attached to the base member 102 in any of a variety of ways. For example, where the base 102 and the support member 104 are made of metal, the base 102 and the support member 104 can be welded together. Where the base 102 and the support member 104 are made of a composite material, the base 102 and the support member 104 can be joined together with glue. Alternatively, the base 102 and the support member 104 may be integrally formed.

In the example of FIG. 1, the support member 104 is illustrated with a rectangular shape. The invention is not, however, limited to this embodiment. Any suitable shape may be employed. For example and without limitation, portions of the support member 104 can be square, round, oblong, or polygonal. Support member 104 can optionally include aesthetically shaped features as well.

The wheel hub support system 100 optionally includes one or more secondary support features. Such secondary support features can be utilized to prevent the support member 104 from bending or collapsing under the weight of a supported vehicle.

FIG. 2 is a look-down cross-sectional view of the wheel hub support system 100, wherein the wheel hub support system 100 includes secondary support members in the form of side walls 202. In the example of FIG. 2, the support member 104 and the side walls 202 form a half-square or half-rectangle cross section. In other embodiments, the support member 104 and one or more secondary support members form an I-shaped cross section. The invention is not, however, limited to these example embodiments.

The one or more secondary support members can be integrally formed with the support member 104. Alternatively, the one or more secondary support members are attached between the support member 104 and the base 102.

From the perspective of FIG. 2, the base 102 has a rectangular shape. In other embodiments, the base 102 has a square shape, or other shape. The base 102 optionally includes aesthetically shaped features. This can correspond to, for example, a trademark, such as a footprint shape to correspond to a trademark of “BigFoot” and/or “LightFoot.”

The dimensions of the base 102 are selected to support at least a portion of the vehicle weight over a surface. For example, where the surface is hard, such as concrete, the dimensions of the plate can be relatively small. In certain circumstances, the base can be omitted. For softer surfaces, the dimensions of the plate can be increased. In one embodiment, the base 102 has a length of between approximately ten and twenty inches, and a width of between approximately three and eight inches. In another embodiment, the base 102 has a length of twenty inches and a width of 5 inches. The invention is not, however, limited to these example dimensions.

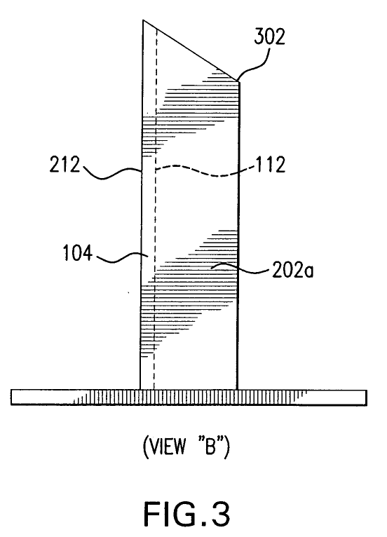

Edges of the wheel hub support system 100 can be rounded to reduce injury. For example, in the example of FIG. 2, corners of the base 102 are rounded. FIG. 3 is a side view of the wheel hub support system 100, wherein corners 302 of the secondary support member 202 are less than 90 degrees.

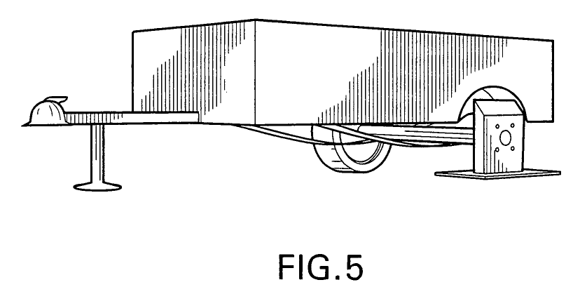

FIG. 5 is a perspective view of a vehicle 500 supported on one side by the wheel hub support system 100.

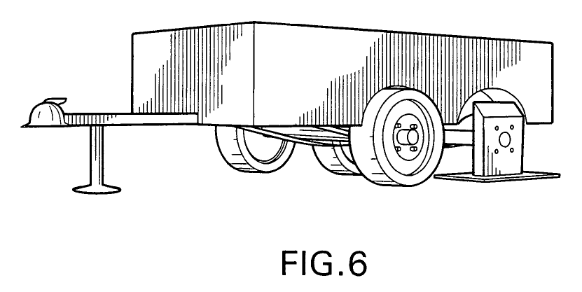

FIG. 6 is a perspective view of a vehicle 600 having multiple wheels on a side, with one wheel replaced by a securable wheel hub support system.

### II. LOCKING MECHANISM

The wheel hub support system 100 is optionally used in conjunction with a locking mechanism to secure the wheel hub support system 100 to a wheel hub, and/or to secure the wheel hub support system 100 to a stationary device. For example, and without limitation, a locking device includes a locking lug nut. Locking lug nuts are available from automobile parts stores and from automobile distributorship service departments. Locking mechanisms are not, however, limited to locking lug nuts.

### IV. LOCK PROTECTION MECHANISM

In one embodiment, where a wheel hub support system is used in conjunction with a locking mechanism, the wheel hub support system further includes a lock protection mechanism that protects the locking mechanism from physical damage due to, for example, a would be thief trying to break the locking mechanism.

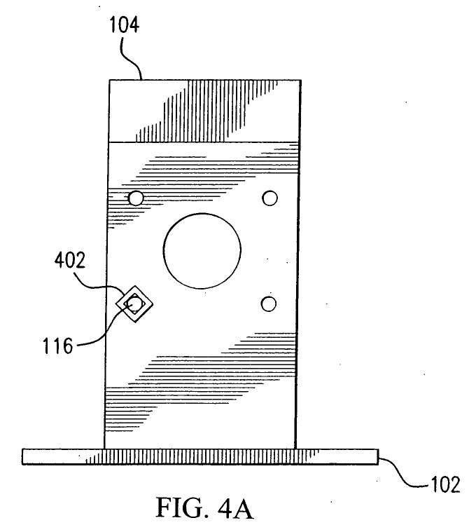

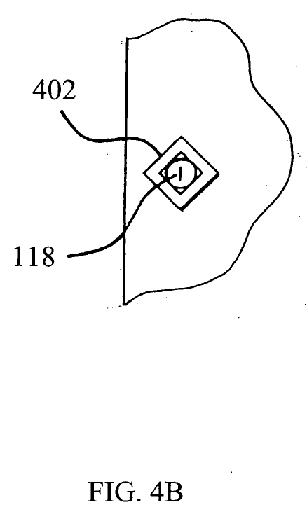

FIG. 4 is a perspective view of the wheel hub support system 100, further including an example lock protection mechanism in the form of a lug nut protector 402. The lug nut protector 402 is positioned proximate to at least one of the lug bolt cut-outs. The lug nut protector 402 protects a locking lug nut from damage from a physical force, such as a blow from a hammer. In the example of FIG. 4, the lug nut protector 402 is centered around a lug-nut cut-out 116.

The lug nut protector 402 is formed from a substantially rigid, durable material, such as metal (e.g., steel or aluminum), and/or a composite material. The lug nut protector 402 can be welded or glued to, or integrally formed with the support member 104.

The lug nut protector 402 can be manufactured from a section of pipe radially sized to allow a wrench to fit over a locking lug nut that is attached to a lug bolt that is inserted through the lug bolt cut-out. The section of piping is longitudinally sized to extend beyond a lug nut applied to a lug bolt that is inserted through the lug bolt cut-out. Alternatively, the section of piping is longitudinally sized to be equal to or less than the length of a lug nut applied to a lug bolt that is inserted through the lug bolt cut-out.

In the example of FIG. 4, lug nut protector 402 has a substantially square cross-section. The invention is not, however, limited to this embodiment. For example, and without limitation, the lug nut protector can have a circular cross-section, a half-circular cross-section, or a half-square cross-section.

### IV. CONCLUSION

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor, and thus, are not intended to limit the present invention and the appended claims in any way.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A system for supporting an axled vehicle, comprising:
a base;
a support member extending upwardly from the base, the support member including first and second surfaces, the support member having a wheel hub cut-out extending between the first and second surfaces, the wheel hub cut-out configured to receive a portion of a wheel hub therethrough, the support member including a plurality of lug bolt cut-outs radially spaced around the circular wheel-hub cut-out, the plurality of lug bolt cut-outs configured to receive lug bolts associated with the wheel hub therethrough; and
a lug nut protector positioned proximate to at least one of the lug bolt cut-outs,
wherein the lug nut protector comprises a section of pipe extending from the first surface of the support member and centered around one of the lug bolt cut-outs, the section of pipe being sized to extend beyond a locking lug nut applied to a lug bolt inserted through the lug bolt cut-out, and
wherein the base, the support member, and the lug nut protector are welded together.

2. (canceled)

3. (canceled)

4. The system according to claim 1, wherein the section of pipe is sized to allow a wrench socket to fit over the locking lug nut.

5. (canceled)

6. The system according to claim 1, wherein the section of pipe has a substantially square cross-section.

7. The system according to claim 1, wherein the section of pipe has a substantially round cross-section.

8. The system according to claim 1, wherein the base, the support member, and the lug nut protector comprise steel.

9. (canceled)

10. The system according to claim 1, wherein the base, the support member, and the lug nut protector comprise aluminum.

11. (canceled)

12. (canceled)

13. (canceled)

14. The system according to claim 1, wherein an upper surface of the base is substantially rectangularly shaped.

15. The system according to claim 14, wherein the upper surface of the base is between approximately ten and twenty inches long and between approximately three and eight inches wide.

16. The system according to claim 14, wherein the upper surface of the base is approximately twenty inches long and approximately five inches wide.

17. (canceled)

18. (canceled)

19. The system according to claim 1, further comprising a second support member coupled to the first support member, wherein the second support member assists in preventing the first support member from bending or collapsing under the weight of a supported vehicle.

20. A system for supporting an axled vehicle, comprising:
a base;
a first support member extending upwardly from the base, the first support member including first and second surfaces, the first support member having a wheel hub cut-out extending between the first and second surfaces, the wheel hub cut-out configured to receive a portion of a wheel hub therethrough, the first support member including a plurality of lug bolt cut-outs radially spaced around the circular wheel-hub cut-out, the plurality of lug bolt cut-outs configured to receive lug bolts associated with the wheel hub therethrough;
a second support member coupled to the first support member, wherein the second support member assists in preventing the first support member from bending or collapsing under the weight of a supported vehicle; and
a lug nut protector positioned proximate to at least one of the lug bolt cut-outs,
wherein the lug nut protector comprises a section of pipe extending from the first surface of the support member and centered around one of the lug bolt cut-outs, the section of pipe being sized to extend beyond a locking lug nut applied to a lug bolt inserted through the lug bolt cut-out.

21. The system according to claim 20, wherein the second support member is integrally formed with the first support member.

22. The system according to claim 20, wherein the second support member is welded to the first support member.

23. The system according to claim 20, wherein the first support member and the second support member form a substantially half-square cross section.

24. The system according to claim 20, wherein the first support member and the second support member form a substantially I-shaped cross section.

25. A system for supporting an axled vehicle, comprising:
a substantially flat base;
a support member extending upwardly from the base, the support member including first and second surfaces, the support member having a wheel hub cut-out extending between the first and second surfaces, the wheel hub cut-out configured to receive a portion of a wheel hub therethrough, the support member including a plurality of lug bolt cut-outs radially spaced around the circular wheel-hub cut-out, the plurality of lug bolt cut-outs configured to receive lug bolts associated with the wheel hub therethrough; and
a lug nut protector positioned proximate to at least one of the lug bolt cut-outs,
wherein the lug nut protector comprises a section of pipe extending from the first surface of the support member and centered around one of the lug bolt cut-outs, the section of pipe being sized to extend beyond a locking lug nut applied to a lug bolt inserted through the lug bolt cut-out.
